(19) United States
(12) Patent Application Publication
(10) Pub. No.: US 2005/0238235 A1
(43) Pub. Date: Oct. 27, 2005

(54) Run length based connected components and contour following for enhancing the performance of circled region extraction algorithm

(76) Inventor: Jinhong K. Guo, West Windsor, NJ (US)

Correspondence Address: GREGORY A. STOBBS, 5445 CORPORATE DRIVE, SUITE 400, TROY, MI, 48098, US

(21) Appl. No.: 11/108,168

(22) Filed: Apr. 15, 2005

Related U.S. Application Data
(63) Continuation-in-part of application No. 09/773,214, filed on Jan. 31, 2001.

(51) Int. Cl. G06K 9/48

(52) U.S. Cl. 382/199

(57) ABSTRACT

A method for identifying contours in image data includes expressing pixel-based image data as a grid of columns and rows. A scan order is established over the grid to define a parent-child relationship between contiguous pixels in adjacent rows and to define a sibling relationship among non-contiguous pixels in the same row. A run data structure is established in computer-readable memory that defines a run member by its row position and by its starting and ending column positions. The run data structure further defines parent, child and sibling structures for storing information about the parent-child relationships and sibling relationships of pixels associated with the run member. The run data structure is used to traverse the parent, child and sibling relationships and thereby identify contours within the pixel-based image data.

### CROSS-REFERENCE TO RELATED APPLICATIONS

This application is a continuation-in-part of U.S. patent application Ser. No. 09/773,214 filed on Jan. 31, 2001, the disclosure of which is incorporated herein by reference.

### BACKGROUND AND SUMMARY OF THE INVENTION

The present invention relates generally to image processing. More particularly, the present invention relates to a method and system for identifying contours within pixel-based image data. The identified contours may be used, for example, to identify circled regions on a scanned document, allowing the image processing system to extract content within the circled region to index the document or perform other processing tasks based on the information.

There is considerable interest today in intelligent, automated document imaging systems that can store and retrieve scanned documents and other pixel-based image data with minimal document coding by the user. In a conventional document imaging system, the scanned image is displayed on the computer screen, and the user may highlight a portion of the scanned image from which indexing information may be extracted. For example, the user could highlight the caption of a scanned newspaper article. The caption is processed through optical character recognition (OCR) and then used as an index or label for that scanned image. The index or label is used to later retrieve the scanned newspaper clipping.

While the use of the computer display to highlight relevant portions of a document works well in some applications, there are other applications where physical interaction with the computer screen is not convenient. In such instances, it may be more convenient for the user to simply encircle the region of interest on the hard copy document prior to scanning it into the system. In other words, the user would use a pencil or pen to draw a circle around the region of interest, and the image processing system would then identify the user's hand-drawn circle, extract and process the text within the circled region, and use it for indexing or document processing purposes.

Identifying a circled region within the pixel-based image data of a scanned document is a fairly challenging problem. Traditional algorithms for identifying circled regions attempt to identify connected components that have a profile of attributes indicating that they might constitute a circled region.

Traditionally, a connected component comprises a collection of black, contiguously adjoining pixels. Depending on the algorithm used, adjoining pixels are those that lie in the immediate neighborhood surrounding a given pixel, typically either the four pixels arranged like points a compass, or the eight pixels including those four plus diagonals. When a conventional connected component analysis is performed, the scanned image may contain a number of connected component candidates which could represent a user-drawn circle. Post processing algorithms are performed on the connected component data to rule out those that are too small, and thus more likely to correspond to individual letters or noise data. Post processing algorithms also examine the connected component data to determine if there is closure within a given connected component. In this way, closed circles are identified and other markings such as marginal lines or underlining are eliminated.

While conventional connected component analysis does a reasonably good job of identifying potential circled region candidates, the process is fairly computationally expensive. The present invention addresses this issue through a far more efficient algorithm. Instead of seeking connected components in the conventional fashion—a process that will potentially generate many candidates that each must be analyzed—the present algorithm uses a single data structure that is populated with run length information as the image is being scanned. As will be more fully explained herein, the data structure maintains parent, child and sibling relationship information about each “run” of contiguous pixels within a given scanned row. The parent, child and sibling information is then traversed to identify contours that represent closed circles of suitable size. The run length algorithm thus eliminates the need to painstakingly explore each pixel to its neighboring pixels in the conventional connected component fashion. Moreover, although the algorithm is well suited for identifying circled regions, in its more general case, the algorithm can be used to identify a variety of different contours that meet a set of predefined criteria. Also, while the present “black-and-white” embodiment seeks to identify runs of contiguous black pixels, the algorithm can readily be extended to accommodate gray scale and color pixel image data as well. In such applications, the system merely needs to identify which pixel states or pixel values (e.g., shades or colors) may constitute a member of a run, and the algorithm will identify contours made up of pixels having any of the identified states or values.

According to one aspect of the invention, the method for identifying contours within pixel-based image data comprises expressing the image data as a grid of columns and rows. A scan order is then established over the grid to define parent-child relationships between contiguous pixels in adjacent rows and sibling relationships among non-contiguous pixels in the same row. A run data structure is established in the computer-readable memory that defines a run member by its row position and by its starting and ending column positions. The run data structure further defines parent, child and sibling structures for storing information about these relationships.

As the image data is scanned according to the scan order established above, the processor identifies contiguous pixels of a predetermined state as identified run members. It also determines the parent-child and sibling relationships of the identified run members. This information is populated into the run data structure with the row position and starting and ending column positions of the identified run member and with the parent-child and sibling relationships of the identified run member. The populated data structure is then traversed by following the parent-child and sibling relationships to identify contours within the pixel-based image data. If desired, once the contours have been identified, additional processing can be performed to improve the likelihood that the identified contour represents a user-drawn circle. These additional processing aids discriminate between one user-drawn circle from another, when two circles overlap. The additional processing involves computing feature points along the contour and then breaking the contour into segments at the feature points. The broken contours are then used to generate reconstructed circles, each having its own identity and thus each being separate from other circles which it may overlap.

For a more complete understanding of the invention, its objects and advantages, refer to the following specification and to the accompanying drawings.

### BRIEF DESCRIPTION OF THE DRAWINGS

FIG. 1 is a pixel diagram illustrating the concepts of run length, parent-child relationships and sibling relationships;

FIG. 2 is a data structure diagram illustrating a presently preferred data structure for implementing the invention;

FIG. 3 is a flow diagram illustrating an algorithm for populating the data structure of FIG. 2;

FIG. 4 is a pixel diagram illustrating an example of a contour, useful in understanding how the data structure of FIG. 2 is populated by applying the algorithm of FIG. 3;

FIG. 5 is a flow diagram illustrating how the data structure is traversed to identify a contour;

FIG. 6 is a pixel diagram illustrating the contour following process of FIG. 5 as applied to the exemplary data of FIG. 4;

FIG. 7 is a pixel diagram illustrating the run length midpoints with 20 darker shading;

FIG. 8 is a pixel diagram, similar to FIG. 6, but showing the two main contours with different line styles to illustrate how the contours are joined;

FIG. 9 is a flow diagram of an enhanced circled region extraction algorithm suitable for discriminating among overlapping circles; and

FIG. 10 is a flow diagram illustrating another algorithm for populating the data structure of FIG. 2.

### DESCRIPTION OF THE PREFERRED EMBODIMENT

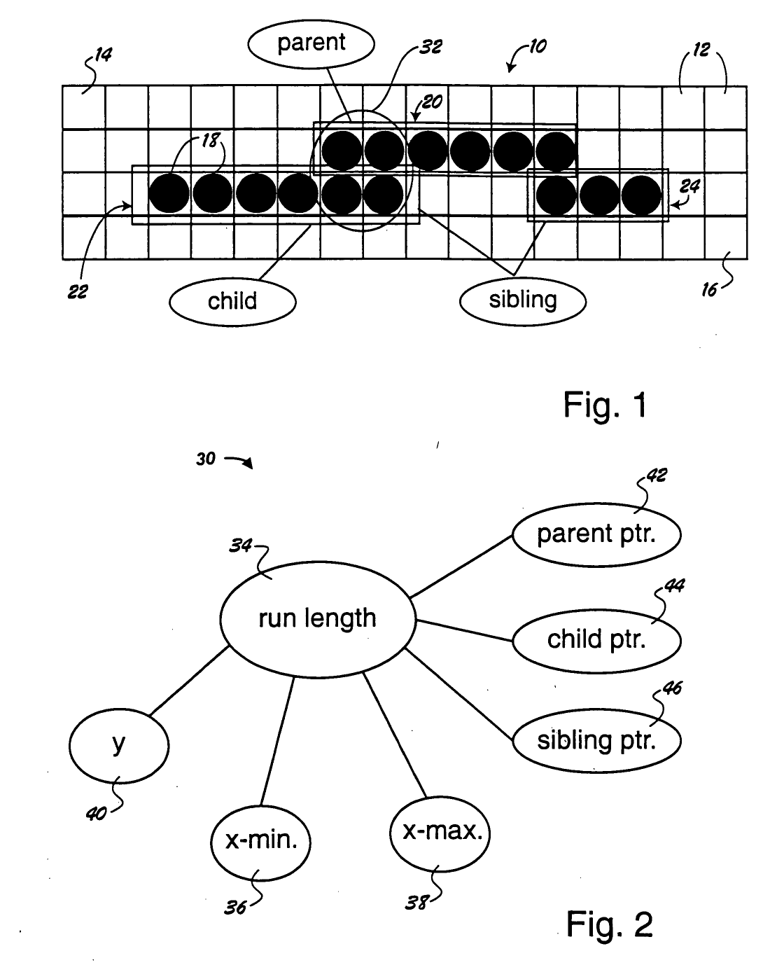

The run length based method of the preferred embodiment scans image data in a pre-established scan order to identify parent, child and sibling structures within the image data. In this regard, the image data may be expressed as a rectangular grid 10 of columns and rows comprising individual pixels that are represented in FIG. 1 as squares 12. In the general case, each pixel may contain a data value representing a particular state, tone or color of which the overall image is made. In black-and-white images, each pixel contains binary data indicating whether that pixel is black or white. In a gray scale image, each pixel may contain a byte or word of data indicating what gray scale tone the pixel represents. In a color image the pixel may contain data indicating the color and intensity of the pixel. The present invention works with all forms of image data, regardless of whether the image is black and white, gray scale or color.

As will be more fully explained below, the processing algorithm scans the grid of pixel data in a predetermined scan order. For illustration purposes, it will be assumed that the scan order is from top to bottom and from left to right. Thus the grid 10 would be scanned beginning at pixel 14 in the upper left-hand corner and ending with pixel 16 in the lower right-hand corner.

The algorithm is designed to identify and correlate groups of adjacent pixels that define a linear string termed a run or run length. The scanning process groups pixels of a predetermined state together to form run lengths within the image.

FIG. 1 a black-and-white image. White pixels appear as white rectangles, such as pixels 12. Black pixels appear as black dots within the pixel square, such as pixels 18. In the typical case, the system is designed to form run lengths from contiguous opaque pixels, such as the black pixels in FIG. 1. However, in the more general case, the system can be used to form run lengths of pixels occupying a variety of different states. For example, if gray scale images are provided, the system could be configured to consider all pixels darker than a predetermined gray scale level to be considered in forming run lengths. In a color image, colors of predetermined intensities or tonal hues may be selected for potential membership in a run length.

The preferred embodiment considers run lengths to be defined by a collection of contiguous pixels of a predetermined state (e.g., the black pixel state in a black-and-white image). Three such run lengths 20, 22, and 24 are illustrated in FIG. 1. Bounding box rectangles have been shown around each of these run lengths to make them more visible. Each run length may be represented by its x (i.e., row) and y (i.e., column) coordinates within grid 10. Because the scan order is performed on a row by row basis, each run length is identified by its beginning and ending column positions and its row position. These three coordinate positions that uniquely identify a run length are stored as the x-minimum 36, x-maximum 38 and y coordinate 40 data values within the run data structure 30 as shown in FIG. 2. Specifically, the run data structure 30 comprises a linked list that includes data values for storing the x-minimum, x-maximum and y-coordinate values for each run length identified during the scanning process.

Individual pixels (such as the black pixels in FIG. 1) are identified as a run length if they occupy contiguous pixel locations within a given row. To accommodate slight imperfections and data dropout in the image, the algorithm can be configured to ignore single pixels (or more) of the incorrect state within a potential run length. This may be done through preprocessing or on the fly as the scanning algorithm performs its other tasks. In effect, if a single white pixel is encountered in what would otherwise be a complete run length, the algorithm can treat that pixel as if it were a black pixel, thereby assigning it to the run length, provided the white pixel is neighbored on both sides by black pixels.

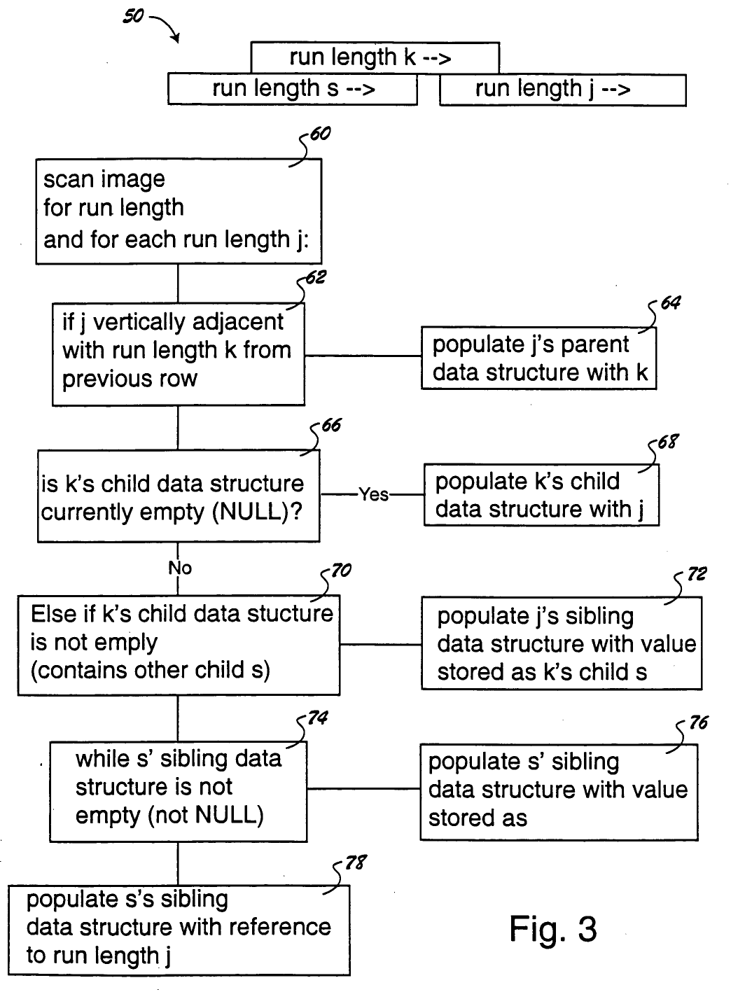

The scanning algorithm and the associated data structure of FIG. 2 define a hierarchy among run lengths. The hierarchy is termed a parent-child-sibling hierarchy. The concept is illustrated in FIG. 1. A parent-child relationship exists where two run lengths have one or more adjacent black pixels (or pixels of whatever predetermined state defines a run length) in a given column. In FIG. 1, run lengths 20 and 22 have two pairs of vertically adjacent pixels (shown circled and identified by reference numeral 32) that qualify these run lengths for the parent-child relationship. Specifically, run length 20 is deemed the parent and run length 22 is deemed the child, because run length 20 is scanned before run length 22. The existence of this parent-child relationship is discovered automatically as the scanning algorithm performs its tasks, and the relationship is recorded in the run data structure 30. The details of how this is accomplished is discussed below in connection with the flow diagram of FIG. 3.

The scanning algorithm and its associated data structure 30 also define a sibling relationship between two run lengths that lie on the same row and share the same parent, such as run lengths 22 and 24. The scanning algorithm automatically detects sibling relationships and stores them in data structure 30, as will be more fully described in connection with FIG. 3.

The presently preferred run data structure 30 defines each run length 34 by its associated x-minimum value 36, x-maximum value 38 and y-coordinate value 40. The run length data structure also has associated with it a parent pointer 42, a child pointer 44 and a sibling pointer 46. The parent, child and sibling pointers 42-46 establish a linked list of the run length data structures. The scanning algorithm populates this data structure as it visits each pixel in grid 10. In the preferred embodiment a single, multiple linked list is populated with individual run length data structures 34 corresponding to each run length identified by the scanning algorithm.

### Run Length Scanning Algorithm

FIG. 3 shows the presently preferred run length scanning algorithm. For purposes of understanding the algorithm it will be assumed that scanning has proceeded to the point where a run length ‘k’ has been identified and the algorithm is currently processing a run length 1′ that has a sibling run length ‘s’.

The relationship of scan lengths k, j and s are shown diagrammatically at 50 for convenience. The scanning algorithm begins at step 60 by scanning the image in the predetermined scan order, searching for occurrences of run lengths. As discussed above, run lengths are identified as contiguous pixels in a common row that have the same pixel state (e.g. contiguous black pixels). The preferred scanning algorithm is recursive. For each run length identified (such as run length ′j) the following process is performed.

If, as illustrated at step 62, the identified run length (j) is vertically adjacent to a run length (k) from a previous row, then the current run length's parent data structure (j's parent data structure) is populated with a reference to the vertically adjacent run length (k), as shown at 64. The scanning algorithm then tests k's child data structure at step 66 to determine if it is currently empty (containing a null value). If a null value is found, the algorithm populates k's child data structure with a reference to scan length j, as illustrated at 68. If k's child data structure is not currently empty (in other words if it contains a reference to another child(s), the algorithm detects this at step 70 and then populates j's sibling data structure with the value stored as k's child(s), as shown at 72. Thus, steps 66-72 essentially test whether the child of k is null. If so, it sets j to the child of k. Otherwise it sets j as the sibling of the child of k.

In some instances the algorithm detects that the child(s) already has a sibling. In this case the algorithm sets the child as the sibling's sibling, and so on. This is shown in steps 74 and 76. When siblings are identified the algorithm sets their respective sibling pointers to each other as shown at step 72 and 78.

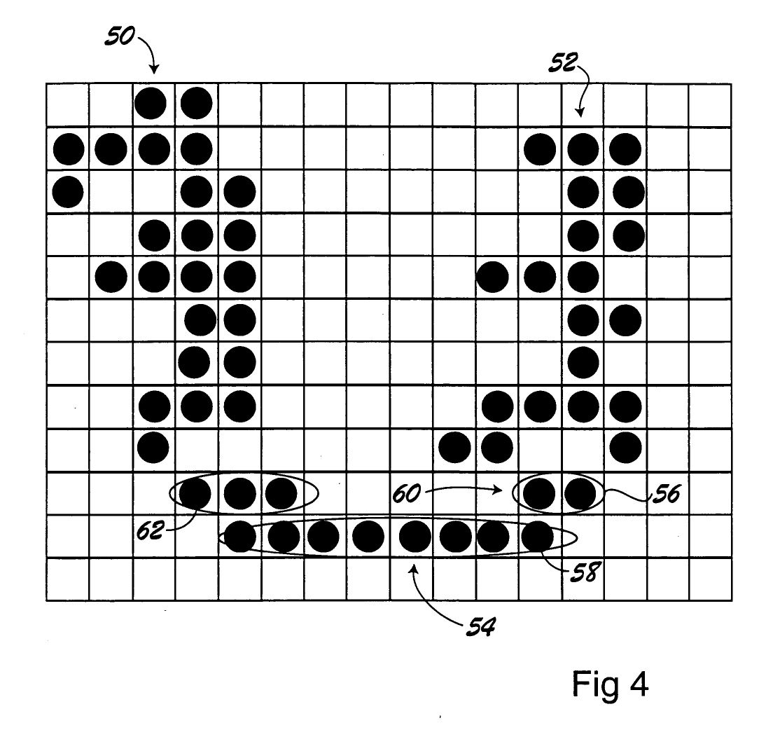

The scanning algorithm illustrated in FIG. 3 populates the run data structure for later retrieval of connected components. The connected component retrieval process operates by tracing from parent to child and from sibling to sibling. FIG. 4 provides an example of an image of a generally u-shaped contour made up of a plurality of individual run lengths. The objective of the connected component retrieval process is to identify this u-shaped contour by tracing the parent-to-child and sibling-to-sibling relationships of the run lengths involved.

Note that the u-shaped contour in FIG. 4 has a left side leg 50 comprised of parent-child relationships when scanned from left to right and from top to bottom. The right side leg 52 is also comprised of parent-child relationships. The left and right side legs are joined by the bottom leg 54. Because the scan order is from left to right and from top to bottom, the point at which bottom leg 54 joins right side leg 52 involves a sibling relationship. Specifically, run length 56 and run length 58 overlap at 60. Run length 56 is thus treated as the sibling of the parent 62 of run length 58.

### Connected Component Retrieval

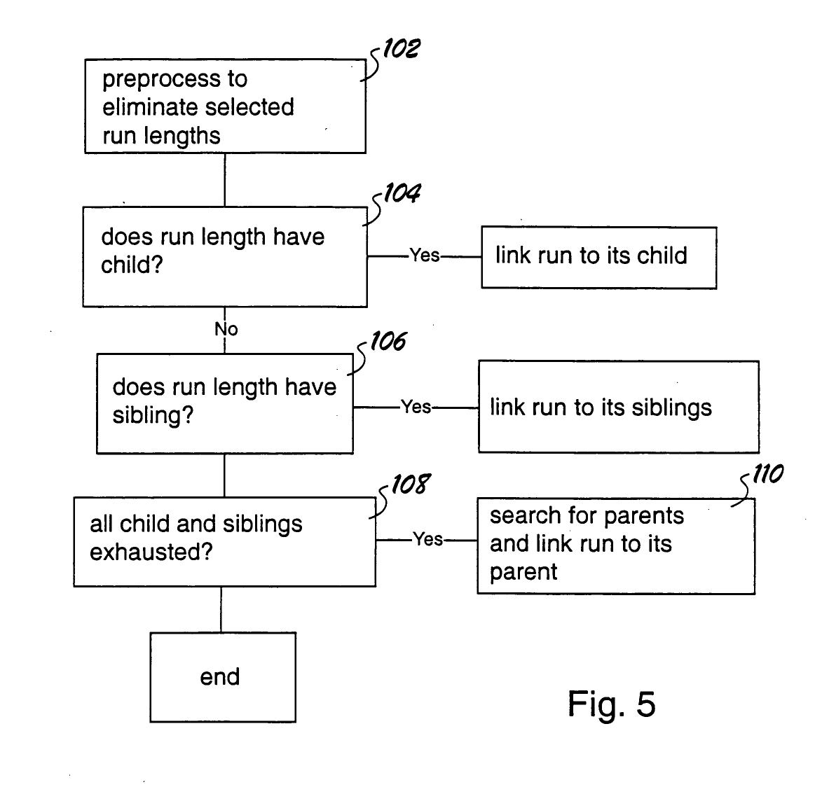

Once the run data structure 30 has been populated by the scanning process, a connected component retrieval process is commenced. Referring to the flow diagram of FIG. 5, the retrieval process makes use of the parent, child and sibling information obtained and stored during initial scanning. This initial screening step is depicted at step 102.

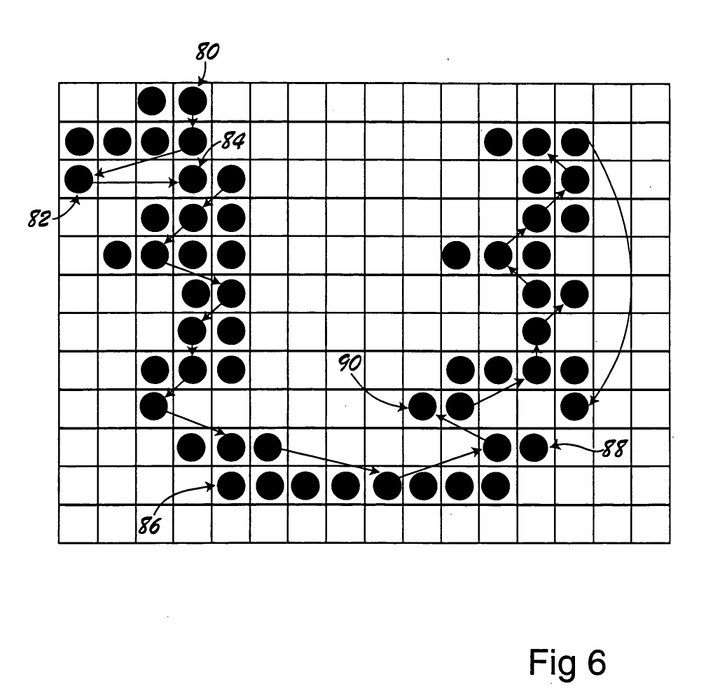

The connected components that remain are processed as follows. Beginning with the run length occupying the upper left-most corner (determined by its x-minimum, x-maximum and y-coordinate values), the process first identifies, by examining the run data structure, if that run length has a child. This is depicted at step 104 and also illustrated in the connected component retrieval diagram of FIG. 6. In FIG. 6 the starting point is indicated at 80. If no child is found, such as in the case of the run length at 82, the procedure links to the sibling 84. The sibling linking step is depicted at 106 in FIG. 5. The procedure is recursive. It continues to seek child and sibling connections until no more children or siblings are identified, as indicated at step 108. This condition occurs at 86 where there is no more children or where there are no more siblings. Once no further children or siblings can be found, the procedure begins looking for parents of a given run length as depicted at step 110. For example, referring to FIG. 5, the procedure would link run link 88 with its parent 90. Eventually, the entire connected component is retrieved, resulting in a linked structure identifying which run lengths are connected to which other run lengths. The entire linked structure thus represents one connected component. Note that it is possible for a given image to have several connected components that are detached from one another. The procedure described in FIG. 5 may be repeated multiple times until all connected components are identified.

While the procedure described so far is well adapted at identifying connected components found in pixel-based images, some image processing tasks, such as identifying circled regions, benefit by further processing. Specifically, the presently preferred embodiment converts the connected component into a contour, which may then be used to generate new structures that are more easily and reliably processed. In an application where user-drawn circles are identified so that the encircled region can be extracted, the connected components are converted into contours. The contours are then used to re-generate circles that are more easily processed by the computer.

The contour following algorithm uses the same data structure that generated the connected components. namely the run data structure 30. When retrieving connected components, the algorithm recursively retrieves the child or parent of each run length. If no child or parent is found, the algorithm switches to siblings. For each sibling, the algorithm continues to search for children and parents first. The parent and child relationship ensures that the related run lengths retrieved have pixels that belong to the same contour and are next to each other in a section of the contour.

In the presently preferred embodiment the contour following algorithm defines the mid-point of each run length. The mid-point P is thus defined by its Px and Py components as follows:

$${P}_{x} = \frac{{x}_{min} + {S}_{max}}{2}$$

$${P}_{y} = {y}_{coordinate}$$

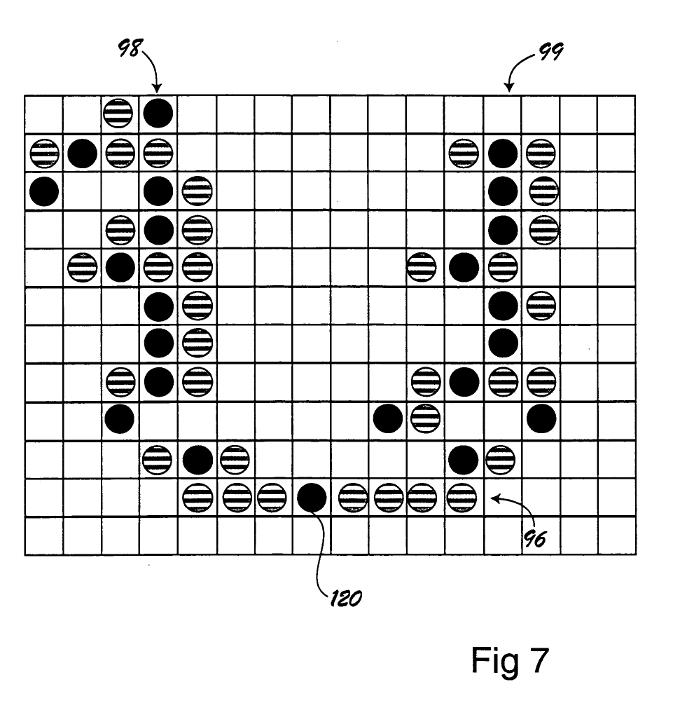

FIG. 7 shows the mid-points of an example run length graph, where the mid-points are marked as dark points and the remaining pixels are marked in lighter cross hatched shading. Note that every time the retrieval switches to one of the siblings, the algorithm starts another contour segment. Thus in FIG. 7, there are two contour segments, a left-most contour segment 98 and a rightmost contour segment 99. The two segments are joined along the horizontal run length 96. These two segments have a common mid-point 120.

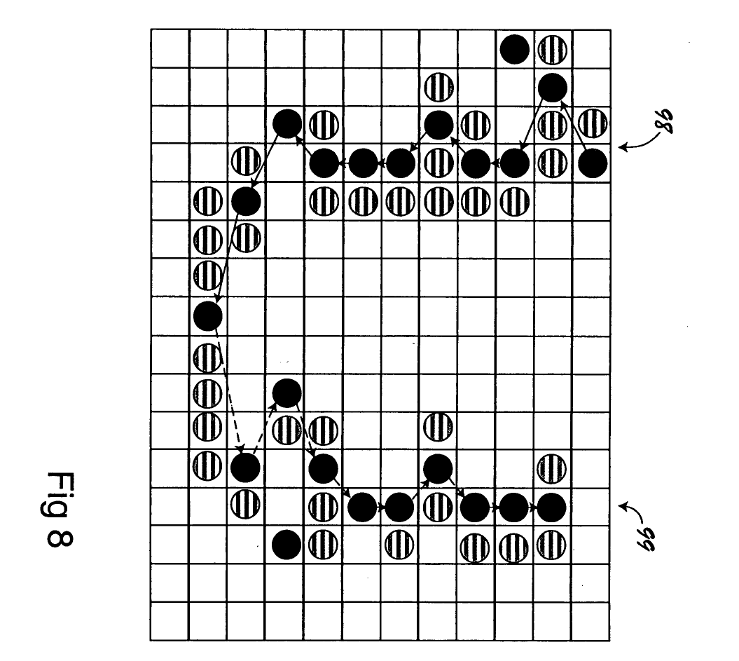

The contour following algorithm assigns the mid-point at the end of a contour to be the beginning mid-point of the subsequent contour. In this way, both contours are linked together, as illustrated in FIG. 8. In FIG. 8 the contour 98 is shown linked together using solid lines and the contour 99 is shown linked with dotted lines.

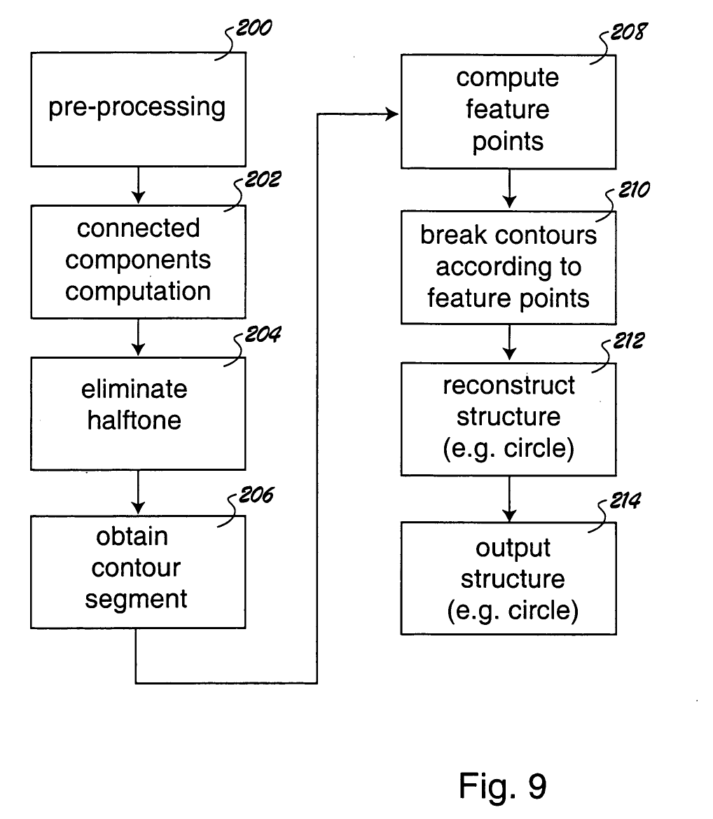

To more fully understand how the run length based connected component analysis may be used in an application, refer to the flow diagram of Figure 9. FIG. 9 illustrates how a user-drawn circle may be identified in a scanned image. The user-drawn circle may, for example, encircle a file designation label or number used to index the scanned image for storage and retrieval.

Beginning at step 200, the procedure first pre-processes the image to convert the image data into suitable resolution and bit-depth for connected component analysis. This is an optional step that may be performed, for example, to convert color image data into black-and-white data or to convert gray scale data into black-and-white data.

The procedure next proceeds to step 202 where connected component analysis is performed using the run length analysis techniques described above. If desired, at step 204, half-tone data may be eliminated and small gaps in pixel data (attributable to noise) may be eliminated. Individual white pixels in an otherwise black pixel domain may be converted to black pixels to “fill in” or de-speckle the image data.

After the connected components have been identified and the run data structure populated, the process advances to step 206, where contour segment information is extracted from the data. The contour segment extraction process is performed as described above, resulting in one or more connected contours, such as the connected contour shown in FIG. 8. The connected contour serves as a “replacement” for the originally drawn circle. Feature points are identified in the contour, step 208, and these feature points are used to break the contour into contour segments, step 210. Breaking the contour according to its feature points is useful in situations where user-drawn circles may contact or overlap other contour structures. The feature points are then used at step 212 to reconstruct circles, which are then output at step 214. The reconstructed circles are generated without gaps or ambiguity regarding closure. Thus the subsequent image processing can be performed more efficiently.

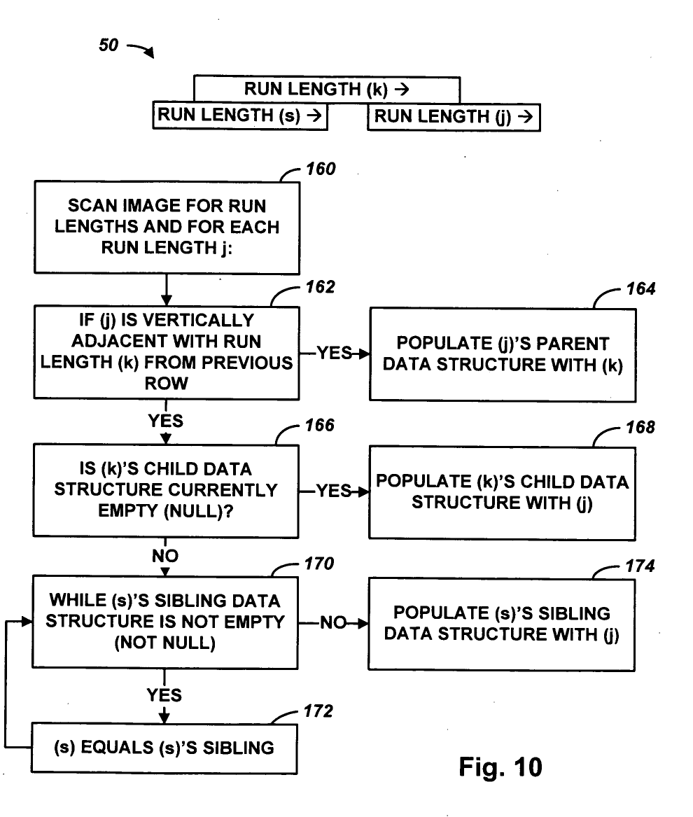

Various alterations to the scanning algorithm can be made that fall within the scope of the present invention. For example, FIG. 10 is a flow diagram of another run length scanning algorithm. The image data is scanned at step 160 to identify run lengths. Then, the run length data structure can be populated with parent-child and sibling relationships based on position of identified run lengths to record their respective positions as at 50. If, as illustrated at step 162, an identified run length (j) is vertically adjacent to a run length (k) from a previous row, then the current run length's parent data structure ((j)'s parent data structure) is populated with a reference to the vertically adjacent run length (k), as shown at 164. The algorithm then tests (k)'s child data structure at step 166 to determine if it is currently empty (contains a null value). If a null value is found, the algorithm populates (k)'s child data structure with a reference to run length 0), as illustrated at 168. If (k)'s child data structure is not currently empty (in other words if it contains a reference to a child (s)), and if the child (s) does not already have a sibling, the algorithm detects this state at 170 and populates (s)'s sibling data structure with (j), as shown at 174. Thus steps 166-172 essentially test whether the child of k is null. If so, it sets (j) to the child of (k). Otherwise it sets (j) as the sibling of (s) in the case where (s) has no other siblings.

In some instances the algorithm will detect that the child (s) already has a sibling. In this case the algorithm checks whether (s)'s sibling has a sibling, and so on. This is shown in steps 170 and 172. When a null reference is finally reached at 170, the null reference is replaced with a reference to (j) as shown at step 174.

The description of the invention is merely exemplary in nature and, thus, variations that do not depart from the gist of the invention are intended to be within the scope of the invention. Such variations are not to be regarded as a departure from the spirit and scope of the invention.

1. A method for identifying contours in image data, comprising:
expressing pixel-based image data as a grid of columns and rows;
establishing a scan order over said grid to define a parent-child relationship between contiguous pixels in adjacent rows and to define a sibling relationship among non-contiguous pixels in the same row;
establishing a run data structure in computer-readable memory that defines a run member by its row position and by its starting and ending column positions, said run data structure further defining parent, child and sibling structures for storing information about the parent-child relationships and sibling relationships of pixels associated with said run member; and
using said run data structure to traverse the parent, child and sibling relationships and thereby identify contours within said pixel-based image data.

2. The method of claim 1, further comprising scanning the image data according to the scan order to identify contiguous pixels of a predetermined state as identified run members.

3. The method of claim 2, further comprising determining parent-child and sibling relationships of the identified run members.

4. The method of claim 3, further comprising populating the run data structure with row position and starting and ending column positions of identified run members and with parent-child and sibling relationships of identified run members.

5. The method of claim 4, further comprising conditionally populating a parent data structure of a current run length for an identified run length (j) with a reference to a vertically adjacent run length (k) based on whether the identified run length (j) is vertically adjacent to the run length (k) from a previous row.

6. The method of claim 5, further comprising conditionally populating (k)'s child data structure with a reference to identified run length (j) based on whether (k)'s child data structure is currently empty.

7. The method of claim 5, further comprising conditionally populating a sibling data structure of a child (s) of run length (k) with a reference to identified run length (j) based on whether (k)'s child data structure already has a child (s), and based on whether a sibling data structure of the child (s) is currently empty.

8. The method of claim 5, further comprising conditionally populating a sibling data structure of a sibling of (k)'s child (s) with a reference to identified run length (j) based on whether (k)'s child data structure already has a child (s), based on whether the sibling data structure of the child (s) already has the sibling, and based on whether the sibling data structure of the sibling of (k)'s child (s) is currently empty.

9. The method of claim 1, further comprising populating the run data structure with parent-child relationships of identified run members by relating adjacent run members from a previous row and a subsequent row as parent and child if the identified run member that is a potential parent currently has no children.

10. The method of claim 9, further comprising populating the run data structure with sibling relationships of identified run members by relating adjacent run members from the subsequent row as siblings if the potential parent already has a child by traversing a chain of siblings of the child and placing the identified run data structure that is a potential child at the end of the chain.

11. An article of manufacture, comprising:
a computer readable storage medium;
first machine instructions stored on said storage medium and operable to cause a computer processor to express pixel-based image data as a grid of columns and rows;
second machine instructions stored on said storage medium and operable to cause the computer processor to establish a scan order over said grid to define a parent-child relationship between contiguous pixels in adjacent rows and to define a sibling relationship among non-contiguous pixels in the same row;
third machine instructions stored on said storage medium and operable to cause the computer processor to establish a run data structure in computer-readable memory that defines a run member by its row position and by its starting and ending column positions, said run data structure further defining parent, child and sibling structures for storing information about the parent-child relationships and sibling relationships of pixels associated with said run member; and
fourth machine instructions stored on said storage medium and operable to cause the computer processor to use said run data structure to traverse the parent, child and sibling relationships and thereby identify contours within said pixel-based image data.

12. The article of manufacture according to claim 11, wherein said fourth machine instructions are operable to cause the computer processor to scan the image data according to the scan order to identify contiguous pixels of a predetermined state as identified run members.

13. The article of manufacture according to claim 12, wherein said fourth machine instructions are operable to cause the computer processor to determine parent-child and sibling relationships of the identified run members.

14. The article of manufacture according to claim 13, wherein said fourth machine instructions are operable to cause the computer processor to populate the run data structure with row position and starting and ending column positions of identified run members and with parent-child and sibling relationships of identified run members.

15. The article of manufacture according to claim 14, wherein said fourth machine instructions are operable to cause the computer processor to conditionally populate a parent data structure of a current run length for an identified run length (j) with a reference to a vertically adjacent run length (k) based on whether the identified run length (j) is vertically adjacent to the run length (k) from a previous row.

16. The article of manufacture according to claim 15, wherein said fourth machine instructions are operable to cause the computer processor to conditionally populate (k)'s child data structure with a reference to identified run length (j) based on whether (k)'s child data structure is currently empty.

17. The article of manufacture according to claim 15, wherein said fourth machine instructions are operable to cause the computer processor to conditionally populate a sibling data structure of a child (s) of run length (k) with a reference to identified run length (j) based on whether (k)'s child data structure already has a child (s), and based on whether a sibling data structure of the child (s) is currently empty.

18. The article of manufacture according to claim 15, wherein said fourth machine instructions are operable to cause the computer processor to conditionally populate a sibling data structure of a sibling of (k)'s child (s) with a reference to identified run length (j) based on whether (k)'s child data structure already has a child (s), based on whether the sibling data structure of the child (s) already has the sibling, and based on whether the sibling data structure of the sibling of (k)'s child (s) is currently empty.

19. The article of manufacture according to claim 11, wherein said fourth machine instructions are operable to cause the computer processor to populate the run data structure with parent-child relationships of identified run members by relating adjacent run members from a previous row and a subsequent row as parent and child if the identified run member that is a potential parent currently has no children.

20. The article of manufacture according to claim 19, wherein said fourth machine instructions are operable to cause the computer processor to populate the run data structure with sibling relationships of identified run members by relating adjacent run members from a row as siblings in the case where the potential parent already has a child by traversing a chain of siblings of the child and placing the identified run data structure that is a potential child at the end of the chain.
